(19) United States
(12) Patent Application Publication
(10) Pub. No.: US 2025/0379403 A1
(43) Pub. Date: Dec. 11, 2025

(54) ELECTRICAL CONNECTOR

(71) Applicant: LOTES CO., LTD., Keelung (TW)

(72) Inventors: Wen-Chang Chang, Keelung (TW); Zhi-Guo Peng, Guangzhou (CN); Qui-Shen Feng, Guangzhou (CN); Po-Jui Chou, Keelung (TW)

(21) Appl. No.: 19/026,961

(22) Filed: Jan. 17, 2025

(30) Foreign Application Priority Data
Jun. 6, 2024 (CN) 202410732749.9

(51) Int. Cl. H01R 13/646

(52) U.S. Cl. CPC H01R 13/646

(57) ABSTRACT

An electrical connector includes a grounding member and a row of terminals arranged side-by-side in a left-right direction. The row of terminals include a signal terminal or a signal terminal group and two ground terminals respectively located at a left side and a right side of the signal terminal or the signal terminal group. No other terminal exists between each of the two ground terminals and the signal terminal or the signal terminal group. Each ground terminal includes a contact portion and a conductive portion. Each ground terminal has at least one contact location connected to the grounding member. A quantity of the contact location of the ground terminal at the left side of the signal terminal or the signal terminal group is different from a quantity of the contact location of the ground terminal at the right side of the signal terminal or the signal terminal group.

### CROSS-REFERENCE TO RELATED PATENT APPLICATION

This non-provisional application claims priority to and the benefit of, pursuant to 35 U.S.C. § 119 (a), patent application Serial No. CN202410732749.9, filed in China on Jun. 6, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector for resonance optimization.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the increasing demand for high speed data transmission, an electrical connector, which serves as the transmission medium, faces significant challenges. The increase in signal frequency or transmission rate means that the electromagnetic coupling within the electrical connector becomes more critical with less tolerance for errors. For such electrical connector, resonance generated by unwanted radiation, coupling and interference between electromagnetic fields may severely impact the electrical characteristics of the electrical connector. To eliminate or mitigate this impact, the technician in the field typically employs a serial connecting member to connect all ground terminals in the electrical connector in series, thus increasing the grounding return path to eliminate or mitigate the aforementioned effects. However, this approach introduces new problems to the technician in the field. When the aforementioned measure fails to meet the needs, further optimization is generally done by merely increasing the size and quantity of the serial connecting member or changing the material of the serial connecting member on the basis of the existing structure. Without considering whether these modifications may effectively eliminate or mitigate the aforementioned impact, and merely considering the optimization, this approach significantly increases the structural complexity or the manufacturing cost of the electrical connector. Thus, the approach is not the best option for optimization to the electrical connector.

Therefore, a heretofore unaddressed need to design a new electrical connector exists in the art to address the aforementioned deficiencies and inadequacies.

### SUMMARY

In view of the deficiencies of the background technology, the present invention is directed to an electrical connector, in which quantities of connections between the two ground terminals at the two sides of the signal terminal or the signal terminal group and the grounding member are provided to be different, thus dispersing the resonance and preventing the resonance from overlapping at the same frequency.

To achieve the foregoing objective, the present invention adopts the following technical solutions:

An electrical connector includes: an insulating body; a grounding member; and a row of terminals accommodated in the insulating body and arranged side-by-side in a left-right direction, wherein the row of terminals comprise a signal terminal or a signal terminal group and a first ground terminal and a second ground terminal respectively located at a left side and a right side of the signal terminal or the signal terminal group, no other terminal exists between the first ground terminal and the signal terminal or the signal terminal group, and no other terminal exists between the second ground terminal and the signal terminal or the signal terminal group; wherein each of the first ground terminal and the second ground terminal comprises a contact portion and a conductive portion, the contact portion is electrically connected to a first component, the conductive portion is electrically connected to a second component, and from the contact portion to the conductive portion, the first ground terminal and the second ground terminal have equal lengths; and wherein the first ground terminal has a plurality of first contact locations connected to the grounding member, a quantity of the first contact locations is a non-zero even number, the second ground terminal has at least one second contact location connected to the grounding member, and a quantity of the at least one second contact location is an odd number.

In certain embodiments, each of the first contact locations and each of the at least one second contact location are staggered in the left-right direction.

In certain embodiments, the second component is a cable, and each of the first contact locations is higher than each of the at least one second contact location.

In certain embodiments, the second component is a printed circuit board (PCB), and each of the first contact locations is lower than each of the at least one second contact location, or viewing along the left-right direction, at least one of the at least one second contact location is located between two of the first contact locations.

In certain embodiments, the insulating body has a recess, a pair of differential signal terminals are provided between the first ground terminal and the second ground terminal, each terminal of the pair of differential signal terminals have an exposing portion located in the same recess, the grounding member has an opening slot and a position limiting portion extending into the opening slot, the position limiting portion is matched and limited with a position limiting block of the insulating body, the opening slot comprises impedance adjusting through slots located at a left side and a right side of the position limiting portion, and viewing along a direction perpendicular to the left-right direction, the impedance adjusting through slots overlap with at least part of the exposing portions.

Further, an electrical connector includes: an insulating body; a grounding member; and a row of terminals accommodated in the insulating body and arranged side-by-side in a left-right direction, wherein the row of terminals comprise a signal terminal or a signal terminal group and two ground terminals respectively located at a left side and a right side of the signal terminal or the signal terminal group, and no other terminal exists between each of the two ground terminals and the signal terminal or the signal terminal group; wherein each of the ground terminals comprises a contact portion and a conductive portion, the contact portion is electrically connected to a first component, the conductive portion is electrically connected to a second component, and from the contact portion to the conductive portion, the two ground terminals have equal lengths; and wherein each of the ground terminals has at least one contact location connected to the grounding member, and a quantity of the at least one contact location of the ground terminal at the left side of the signal terminal or the signal terminal group is different from a quantity of the at least one contact location of the ground terminal at the right side of the signal terminal or the signal terminal group.

In certain embodiments, one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has at least one first contact location connected to the grounding member, the second ground terminal has at least one second contact location connected to the grounding member, and each of the at least one first contact location and each of the at least one second contact location are staggered in the left-right direction.

In certain embodiments, one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has at least one first contact location connected to the grounding member, the second ground terminal has at least one second contact location connected to the grounding member, the second component is a cable, and each of the at least one first contact location is higher than each of the at least one second contact location.

In certain embodiments, one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has at least one first contact location connected to the grounding member, the second ground terminal has at least one second contact location connected to the grounding member, the second component is a printed circuit board (PCB), and each of the at least one first contact location is lower than each of the at least one second contact location.

In certain embodiments, one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has a plurality of first contact locations connected to the grounding member, the second ground terminal has at least one second contact location connected to the grounding member, the second component is a printed circuit board (PCB), and viewing along the left-right direction, at least one of the at least one second contact location is located between two of the first contact locations.

In certain embodiments, the insulating body has a recess, a pair of differential signal terminals are provided between the two ground terminals, each terminal of the pair of differential signal terminals have an exposing portion located in the same recess, the grounding member has an opening slot and a position limiting portion extending into the opening slot, the position limiting portion is matched and limited with a position limiting block of the insulating body, the opening slot comprises impedance adjusting through slots located at a left side and a right side of the position limiting portion, and viewing along a direction perpendicular to the left-right direction, the impedance adjusting through slots overlap with at least part of the exposing portions.

Further, an electrical connector includes: an insulating body; a grounding member; and a row of terminals accommodated in the insulating body and arranged side-by-side in a left-right direction, wherein the row of terminals comprise a plurality of pairs of differential signal terminals and a plurality of ground terminals, one of the ground terminals is provided at each of a left side and a right side of each pair of the differential signal terminals, and no other terminal is provided between each pair of the differential signal terminals and the two ground terminals correspondingly located at the left side and the right side thereof; wherein each of the ground terminals has at least one contact location connected to the grounding member, and a quantity of the at least one contact location of the ground terminal at the left side of each pair of the differential signal terminals is different from a quantity of the at least one contact location of the ground terminal at the right side of each pair of the differential signal terminals.

In certain embodiments, one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has at least one first contact location connected to the grounding member, the second ground terminal has at least one second contact location connected to the grounding member, and each of the at least one first contact location and each of the at least one second contact location are staggered in the left-right direction.

In certain embodiments, one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has at least one first contact location connected to the grounding member, the second ground terminal has at least one second contact location connected to the grounding member, the second component is a cable, and each of the at least one first contact location is higher than each of the at least one second contact location.

In certain embodiments, one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has at least one first contact location connected to the grounding member, the second ground terminal has at least one second contact location connected to the grounding member, the second component is a printed circuit board (PCB), and each of the at least one first contact location is lower than each of the at least one second contact location.

In certain embodiments, one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has a plurality of first contact locations connected to the grounding member, the second ground terminal has at least one second contact location connected to the grounding member, the second component is a printed circuit board (PCB), and viewing along the left-right direction, at least one of the at least one second contact location is located between two of the first contact locations.

In certain embodiments, the insulating body has a recess, each of the pair of differential signal terminals have an exposing portion located in the same recess, the grounding member has an opening slot and a position limiting portion extending into the opening slot, the position limiting portion is matched and limited with a position limiting block of the insulating body, the opening slot comprises impedance adjusting through slots located at a left side and a right side of the position limiting portion, and viewing along a direction perpendicular to the left-right direction, the impedance adjusting through slots overlap with at least part of the exposing portions.

Compared to the related art, the present invention has the following beneficial effects:

In the electrical connector, the row of terminals include a signal terminal or a signal terminal group and two ground terminals respectively located at a left side and a right side of the signal terminal or the signal terminal group, and no other terminal exists between each of the two ground terminals and the signal terminal or the signal terminal group. One of the two ground terminals is defined as a first ground terminal, and the other of the two ground terminals is defined as a second ground terminal. The first ground terminal has at least one first contact location connected to the grounding member, and the second ground terminal has at least one second contact location connected to the grounding member. In the present invention, a quantity of the first contact location and a quantity of the second contact location are provided to be different, such that a difference exists between the capacitance between the first ground terminal and the signal terminal or the signal terminal group between the first ground terminal and the second ground terminal and the capacitance between the second ground terminal and the signal terminal or the signal terminal group between the first ground terminal and the second ground terminal (note that the signal terminal may be a signal terminal transmitting the single-ended signals, and the signal terminal group may be a pair of differential signal terminals), and a quantity of the grounding paths on the first ground terminal and a quantity of the grounding paths on the second ground terminal are different, such that the electrical connector generates minor resonances at various frequencies. In other words, the difference of the capacitances and the inconsistent quantities of the grounding paths result in the frequency of the resonance generated by the first ground terminal and the frequency of the resonance generated by the second ground terminal being different. On one hand, from the perspective of industry standards, it may prevent the resonances from accumulating at the same frequency, which causes that the resonance at a frequency point not satisfying with the industry association standards. On the other hand, from the perspective of the actual performances of the electrical connector, if a transmission system including the electrical connector transmits the signals at a frequency A (operating frequency), and the change in the resonance frequency may cause the resonance originally occurring at the operating frequency A to shift to a frequency B different from the frequency A, and for the transmission system, the resonances occurring at frequencies other than the operating frequency A (such as the frequency B) has little impact on the transmission system. Therefore, the overall performance of the electrical connector is optimized.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a partial perspective exploded view of a row of terminals, an insulating body and a grounding member according to a first embodiment of the present invention.

FIG. 2 is a partial plain view of the row of terminals, the insulating body and the grounding member according to the first embodiment of the present invention.

FIG. 3 is a perspective exploded view of a portion of the row of terminals and a portion of the grounding member according to the first embodiment of the present invention.

FIG. 4 is a perspective exploded view of a portion of a row of terminals and a portion of a grounding member according to a second embodiment of the present invention.

FIG. 5 is a partial perspective view of the row of terminals and the grounding member according to the second embodiment of the present invention.

FIG. 6 is a partial plain view of the row of terminals and the grounding member according to the second embodiment of the present invention.

FIG. 7 is a perspective exploded view of a portion of a row of terminals and a portion of a grounding member according to a third embodiment of the present invention.

FIG. 8 is a partial perspective view of the row of terminals and the grounding member according to the third embodiment of the present invention.

FIG. 9 is a partial plain view of the row of terminals and the grounding member according to the third embodiment of the present invention.

FIG. 10 is a perspective exploded view of a portion of a row of terminals and a portion of a grounding member according to a fourth embodiment of the present invention.

FIG. 11 is a partial perspective view of the row of terminals and the grounding member according to the fourth embodiment of the present invention.

FIG. 12 is a partial plain view of the row of terminals and the grounding member according to the fourth embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

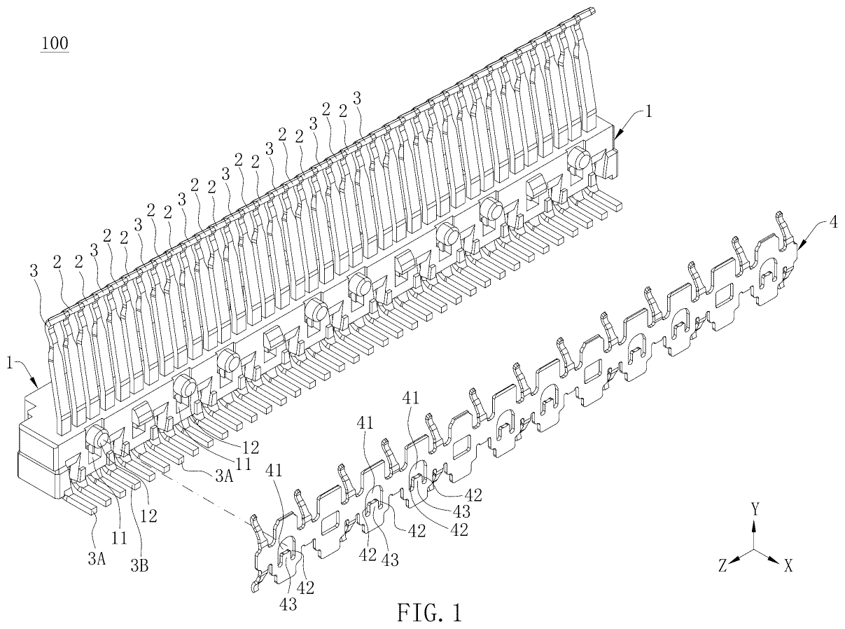

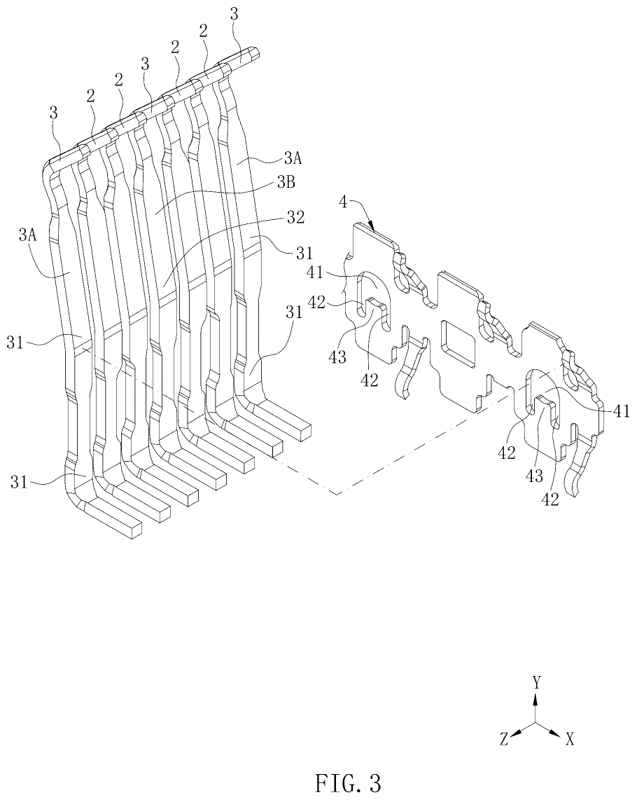

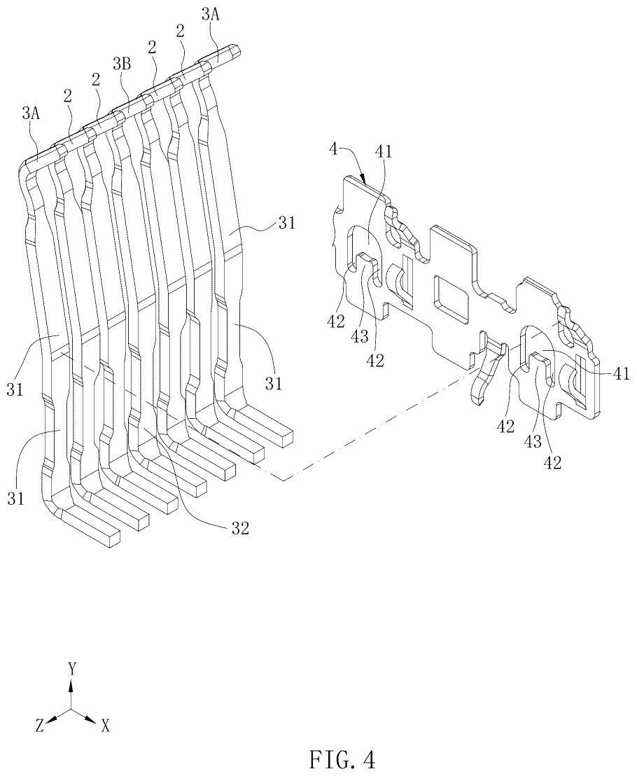

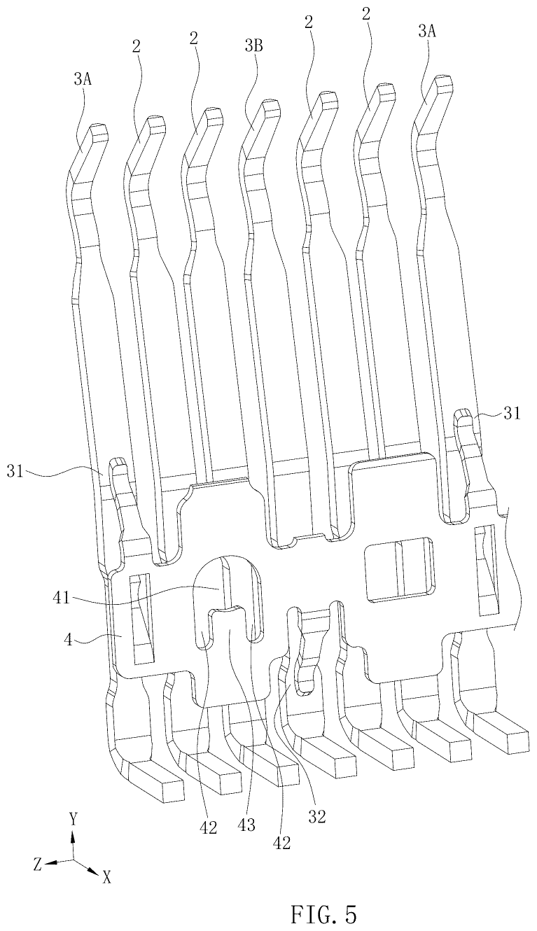

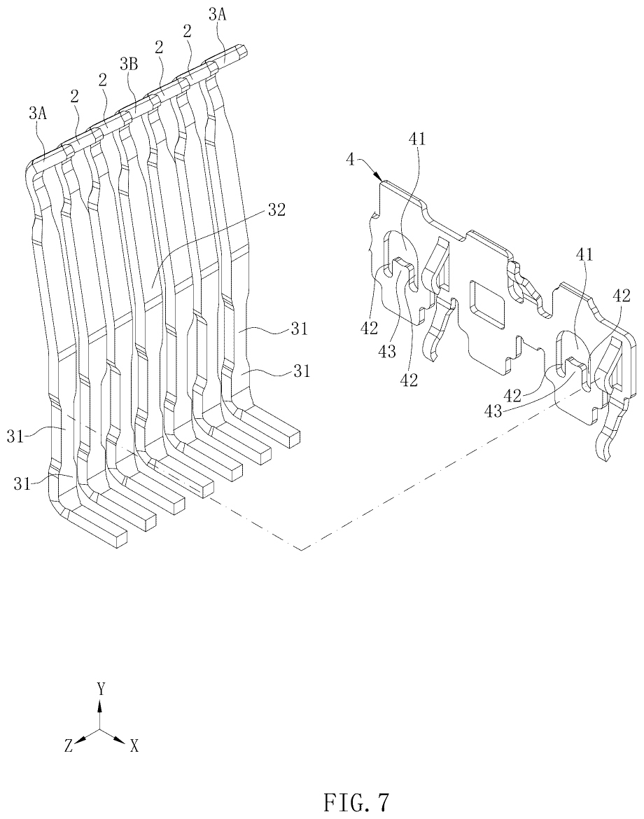

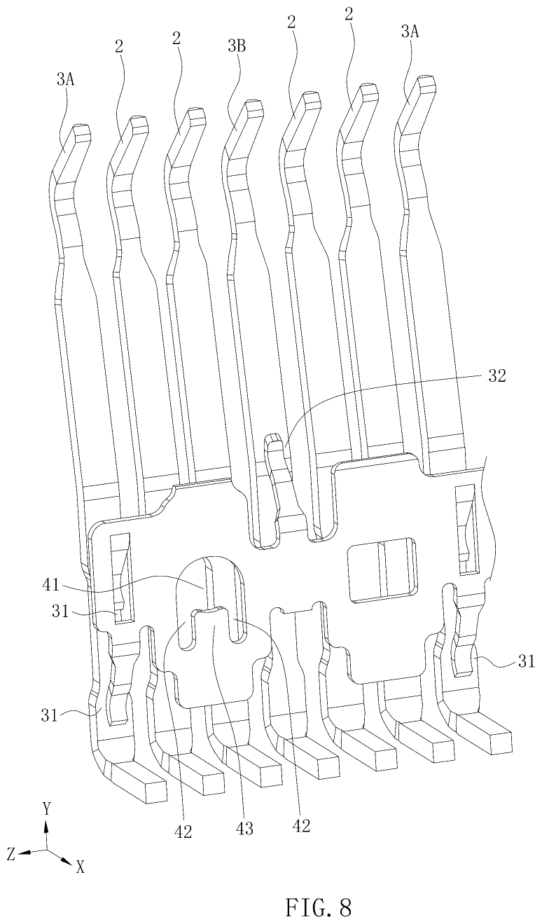

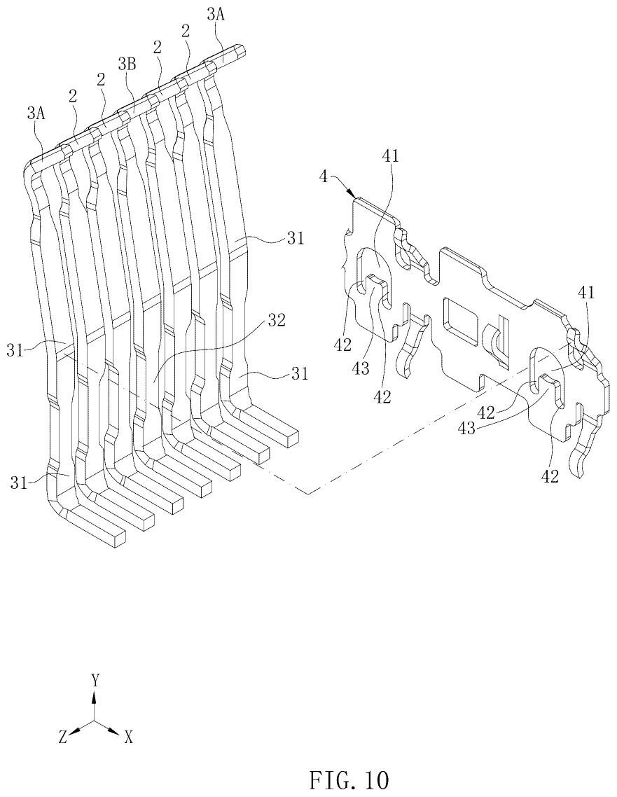

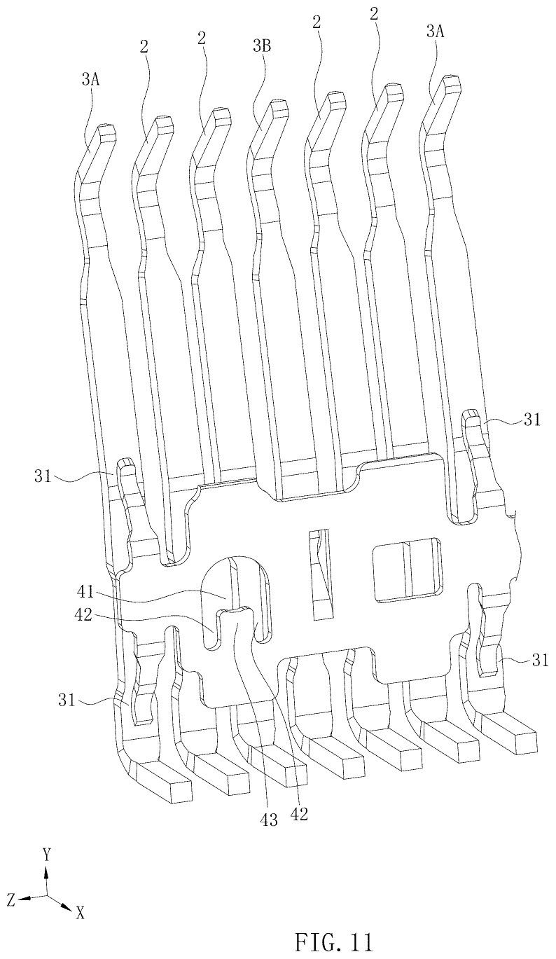

The description will be made as to the embodiments of the present invention in conjunction with the accompanying drawings in FIGS. 1-12. In accordance with the purposes of this invention, as embodied and broadly described herein, this invention, in one aspect, relates to an electrical connector.

As shown in FIG. 1 to FIG. 12, in an electrical connector 100 according to certain embodiments of the present invention, a front-rear direction is defined as the X-axis, a vertical direction is defined as the Y-axis, and a left-right direction is defined as the Z-axis. It should be noted that the directions of up, down, left and right are merely provided for understanding of the embodiments of the present invention, without limiting the present invention thereto. The electrical connector 100 according to certain embodiments of the present invention may be any type of an upright connector, a horizontal connector or a right-angle connector.

As shown in FIG. 1, the electrical connector 100 includes an insulating body 1, a grounding member 4 fixed to the insulating body 1, and a row of terminals accommodated in the insulating body 1. The row of terminals include a pair of differential signal terminals 2 and two ground terminals 3 located at a left side and a right side of the pair of differential signal terminals 2. One of the two ground terminals 3 is defined as a first ground terminal 3A, and the other thereof is defined as a second ground terminal 3B. It should be noted that no other terminal exists between the first ground terminal 3A and the pair of differential signal terminals 2, and no other terminal exists between the second ground terminal 3B and the pair of differential signal terminals 2. Each first ground terminal 3A has two first contact locations 31 in contact with the grounding member 4, and each second ground terminal 3B has one second contact location 32 in contact with the grounding member 4. The grounding member 4 may be made of a metal material or other conductive materials, such as conductive plastic.

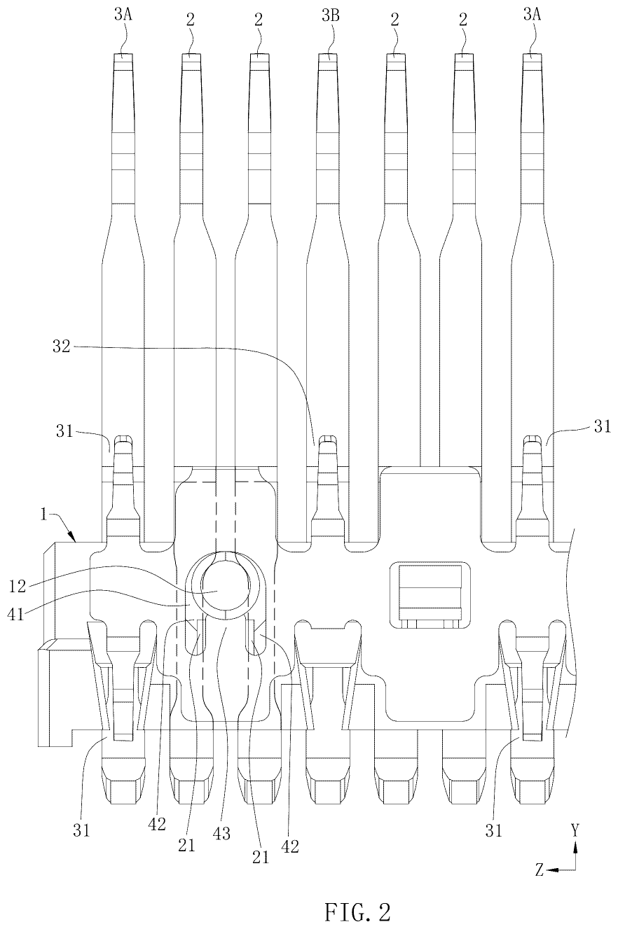

As shown in FIG. 2 to FIG. 12, in certain embodiments, a quantity of the first contact locations 31 on a first ground terminal 3A is a non-zero even number, and a quantity of the second contact locations 32 on a second ground terminal 3B is an odd number. In other words, it is possible that two first contact locations 31 are provided, and one second contact location 32 is provided. It is also possible that two first contact locations 31 are provided, and five second contact locations 32 are provided. As long as it is ensured that the quantity of the first contact locations 31 is a non-zero even number, and the quantity of the second contact locations 32 is an odd number, the present invention does not limit the difference between the quantity of the first contact locations 31 and the quantity of the second contact locations 32.

It should be noted that, in certain embodiments, according to the needs, it is also possible that a quantity of the first contact locations 31 is different from a quantity of the second contact locations 32. That is, the quantity of the first contact locations 31 may be more than the quantity of the second contact locations 32, or that the quantity of the first contact locations 31 is less than the quantity of the second contact locations 32. Further, in these embodiments, the quantities are not limited to be odd or even. For example, when one second contact location 32 is provided, it is possible to provide three first contact locations 31. Alternatively, it is possible to provide two first contact locations 31 and four contact locations 32. Similarly, the present invention does not limit the difference between the quantity of the first contact locations 31 and the quantity of the second contact locations 32.

Further, within the scope of consideration, one of the first contact locations 31 is preferably located at a quarter or three-quarters of the wavelength of the frequency of the signals transmitted by the electrical connector 100. Similarly, one of the second contact locations 32 is also preferably located at a quarter or three-quarters of the wavelength of the frequency of the signals transmitted by the electrical connector 100. If there are other considerations, it is possible to provide these contact locations at other positions according to the needed.

It should be noted that, for the row of terminals, it is possible to replace the pair of differential signal terminals 2 by a signal terminal transmitting single-ended signals according to the needs. Further, it is also possible to provide the contact locations between the two ground terminals 3 located at the two sides of the pair of the differential signal terminals 2 or the signal terminal transmitting single-ended signals and the grounding member 4 to be different from each other. For example, each differential pair may be represented as SS, and each ground terminal 3 may be represented as G. When the row of terminals are formed as G1-SS-G2-SS-G3-SS-G4-SS-G5, in which the ground terminals 3 are represented as G1 to G5 for better descriptions, for the five ground terminals 3 G1 to G5, the quantities of the contact locations respectively on the ground terminals G1 and G2 in contact with the grounding member 4 are different, the quantities of the contact locations respectively on the ground terminals G2 and G3 in contact with the grounding member 4 are different, the quantities of the contact locations respectively on the ground terminals G3 and G4 in contact with the grounding member 4 are different, and the quantities of the contact locations respectively on the ground terminals G4 and G5 in contact with the grounding member 4 are different. It is also possible that, in the row of terminals, only some of the terminals are provided in this way. For example, each differential pair may be represented as SS, and each ground terminal 3 may be represented as G. When the row of terminals are formed as G1-SS-G2-SS-G3-SS-G4-SS-G5, in which the ground terminals 3 are represented as G1 to G5 for better descriptions, for the five ground terminals 3 G1 to G5, it is possible that only the quantity of the contact locations on the ground terminal G1 in contact with the grounding member 4 is different from the quantities of the contact locations respectively on the ground terminals G2 to G5 in contact with the grounding member 4, and the quantities of the contact locations respectively on the ground terminals G2, G3, G4 and G5 may be identical.

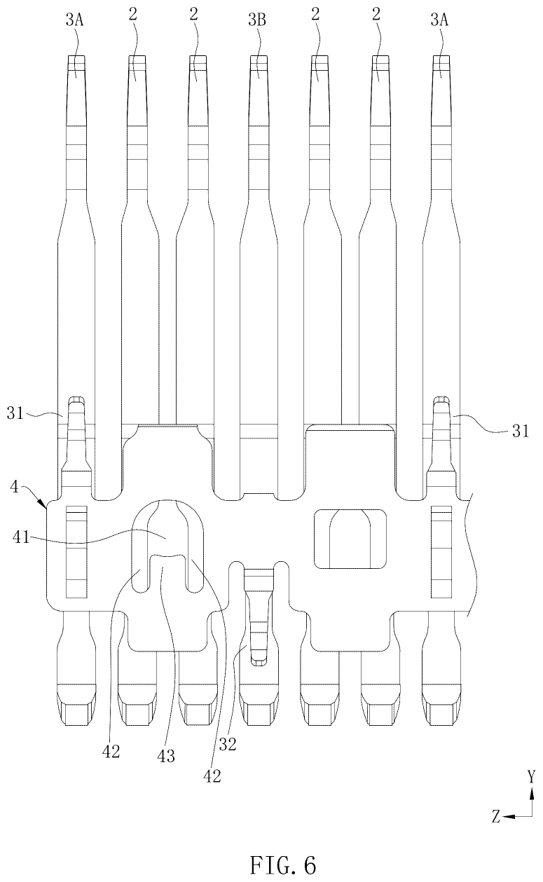

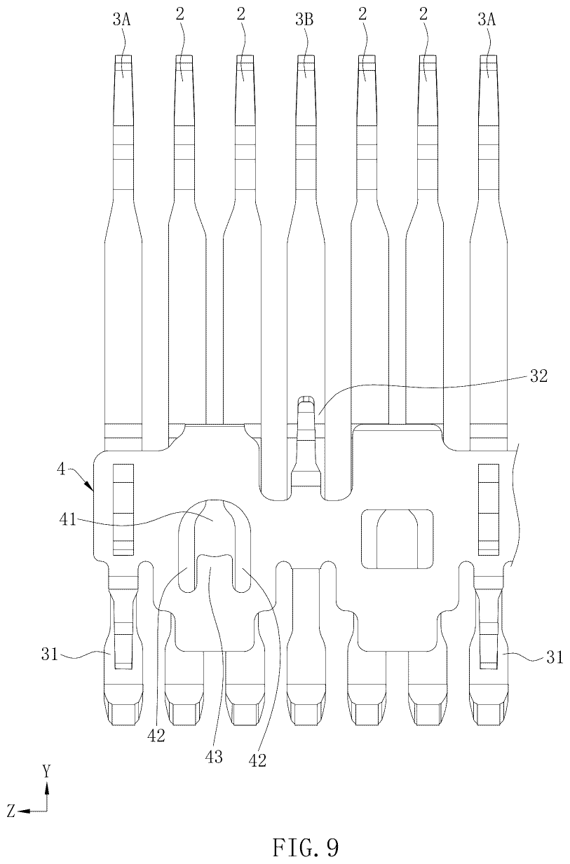

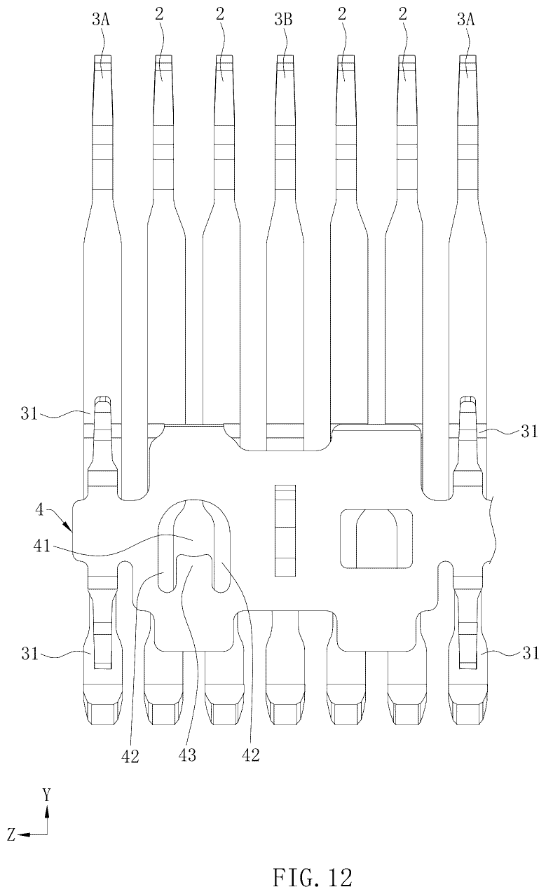

In addition to the limitations of the quantities, it is also possible to adjust the relationship of the positions between the contact locations. As shown in FIG. 6, FIG. 9 and FIG. 12, it is possible that each of the first contact locations 31 and each of the second contact locations 32 are staggered in the left-right direction. Alternatively, as shown in FIG. 9, each of the first contact locations 31 is lower than each of the second contact locations 32. Alternatively, as shown in FIG. 12, viewing along the left-right direction, a second contact location 32 is located between two of the first contact locations 31. It should be noted that, if multiple second contact locations 32 are provided, viewing along the left-right direction, one of the second contact locations 32 may be selected to be located between two of the first contact locations 31, or all of the second contact locations 32 may be selected to be located between two of the first contact locations 31. When the electrical connector 100 is connected to a printed circuit board (PCB), the configuration has a better effect. As shown in FIG. 6, it is also possible that each of the first contact locations 31 is higher than each of the second contact locations 32. When the electrical connector 100 is connected to a cable, the configuration has a better effect.

As shown in FIG. 2, the insulating body 1 has a recess 11, and each of the pair of differential signal terminals 2 respectively has an exposing portion 21 located in the same recess 11. The grounding member 4 has an opening slot 41 and a position limiting portion 43 extending into the opening slot 41, and the position limiting portion 43 is matched and limited with a position limiting block 12 of the insulating body 1. The opening slot 41 includes impedance adjusting through slots 42 located at a left side and a right side of the position limiting portion 43. Viewing along a direction perpendicular to the left-right direction, the impedance adjusting through slots 42 overlap with a part of the exposing portions 21. In the second, third and fourth embodiments of the present invention, although the insulating body 1 is not shown, the other embodiments may have the insulating body 1 identical to the aforementioned structure in the first embodiment.

In sum, the present invention has the following beneficial effects:

1. In the electrical connector 100, the row of terminals include a signal terminal or a signal terminal group and two ground terminals 3 respectively located at a left side and a right side of the signal terminal or the signal terminal group, and no other terminal exists between each of the two ground terminals 3 and the signal terminal or the signal terminal group. One of the two ground terminals 3 is defined as a first ground terminal 3A, and the other of the two ground terminals 3 is defined as a second ground terminal 3B. The first ground terminal 3A has at least one first contact location 31 connected to the grounding member 4, and the second ground terminal 3B has at least one second contact location 32 connected to the grounding member 4. In the present invention, a quantity of the first contact location 31 and a quantity of the second contact location 32 are provided to be different, such that a difference exists between the capacitance between the first ground terminal 3A and the signal terminal or the signal terminal group between the first ground terminal 3A and the second ground terminal 3B and the capacitance between the second ground terminal 3B and the signal terminal or the signal terminal group between the first ground terminal 3A and the second ground terminal 3B (note that the signal terminal may be a signal terminal transmitting the single-ended signals, and the signal terminal group may be a pair of differential signal terminals 2), and a quantity of the grounding paths on the first ground terminal 3A and a quantity of the grounding paths on the second ground terminal 3B are different, such that the electrical connector 100 generates minor resonances at various frequencies. In other words, the difference of the capacitances and the inconsistent quantities of the grounding paths result in the frequency of the resonance generated by the first ground terminal 3A and the frequency of the resonance generated by the second ground terminal 3B being different. On one hand, from the perspective of industry standards, it may prevent the resonances from accumulating at the same frequency, which causes that the resonance at a frequency point not satisfying with the industry association standards. On the other hand, from the perspective of the actual performances of the electrical connector 100, if a transmission system including the electrical connector 100 transmits the signals at a frequency A (operating frequency), and the change in the resonance frequency may cause the resonance originally occurring at the operating frequency A to shift to a frequency B different from the frequency A, and for the transmission system, the resonances occurring at frequencies other than the operating frequency A (such as the frequency B) has little impact on the transmission system. Therefore, the overall performance of the electrical connector 100 is optimized.

2. Actually, the connecting locations and the connection quantities between the grounding member 4 and the ground terminals 3 may affect the frequency of the resonance occurred. Thus, the resonance frequency may be fine-tuned according to the needs, such that the occurrence of the resonance satisfies the needs of the electrical connector 100. In addition, the application environment of the electrical connector 100 also affects the selection of the positional relationships between the first contact locations 31 and the second contact locations 32. For example, for the cable, if the conductive portion of each terminal of the electrical connector 100 is directly connected to the cable, it may be chosen to make each first contact location 31 to be higher than each second contact location 32. If the conductive portion of each terminal of the electrical connector 100 is directly connected to the PCB, it may be chosen to make each first contact location 31 and each second contact location 32 staggered in the left-right direction, or to make each first contact location 31 to be lower than each second contact location 32, or to have at least one of the second contact locations 32 located between two of the first contact locations 31 when viewing along the left-right direction. The aforementioned description is merely a suggested application environment for the positional relationship between the first contact locations 31 and the second contact locations 32, and adjustments may be made according to the needs.

3. The impedance adjusting through slots 42 at least partially overlap with the exposing portions 21, thus actually reducing the areas of the grounding member 4 right facing toward each of the pair of differential signal terminals 2, thereby adjusting the impedance of each of the pair of differential signal terminals 2. In other words, it considers the position limiting constraints within the electrical connector 100 and also takes into account the high frequency characteristics.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body;
a grounding member; and
a row of terminals accommodated in the insulating body and arranged side-by-side in a left-right direction, wherein the row of terminals comprise a signal terminal or a signal terminal group and a first ground terminal and a second ground terminal respectively located at a left side and a right side of the signal terminal or the signal terminal group, no other terminal exists between the first ground terminal and the signal terminal or the signal terminal group, and no other terminal exists between the second ground terminal and the signal terminal or the signal terminal group;
wherein each of the first ground terminal and the second ground terminal comprises a contact portion and a conductive portion, the contact portion is electrically connected to a first component, the conductive portion is electrically connected to a second component, and from the contact portion to the conductive portion, the first ground terminal and the second ground terminal have equal lengths; and
wherein the first ground terminal has a plurality of first contact locations connected to the grounding member, a quantity of the first contact locations is a non-zero even number, the second ground terminal has at least one second contact location connected to the grounding member, and a quantity of the at least one second contact location is an odd number.

2. The electrical connector according to claim 1, wherein each of the first contact locations and each of the at least one second contact location are staggered in the left-right direction.

3. The electrical connector according to claim 1, wherein the second component is a cable, and each of the first contact locations is higher than each of the at least one second contact location.

4. The electrical connector according to claim 1, wherein the second component is a printed circuit board (PCB), and each of the first contact locations is lower than each of the at least one second contact location, or viewing along the left-right direction, at least one of the at least one second contact location is located between two of the first contact locations.

5. The electrical connector according to claim 1, wherein the insulating body has a recess, a pair of differential signal terminals are provided between the first ground terminal and the second ground terminal, each terminal of the pair of differential signal terminals have an exposing portion located in the same recess, the grounding member has an opening slot and a position limiting portion extending into the opening slot, the position limiting portion is matched and limited with a position limiting block of the insulating body, the opening slot comprises impedance adjusting through slots located at a left side and a right side of the position limiting portion, and viewing along a direction perpendicular to the left-right direction, the impedance adjusting through slots overlap with at least part of the exposing portions.

6. An electrical connector, comprising:
an insulating body;
a grounding member; and
a row of terminals accommodated in the insulating body and arranged side-by-side in a left-right direction, wherein the row of terminals comprise a signal terminal or a signal terminal group and two ground terminals respectively located at a left side and a right side of the signal terminal or the signal terminal group, and no other terminal exists between each of the two ground terminals and the signal terminal or the signal terminal group;
wherein each of the ground terminals comprises a contact portion and a conductive portion, the contact portion is electrically connected to a first component, the conductive portion is electrically connected to a second component, and from the contact portion to the conductive portion, the two ground terminals have equal lengths; and
wherein each of the ground terminals has at least one contact location connected to the grounding member, and a quantity of the at least one contact location of the ground terminal at the left side of the signal terminal or the signal terminal group is different from a quantity of the at least one contact location of the ground terminal at the right side of the signal terminal or the signal terminal group.

7. The electrical connector according to claim 6, wherein one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has at least one first contact location connected to the grounding member, the second ground terminal has at least one second contact location connected to the grounding member, and each of the at least one first contact location and each of the at least one second contact location are staggered in the left-right direction.

8. The electrical connector according to claim 6, wherein one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has at least one first contact location connected to the grounding member, the second ground terminal has at least one second contact location connected to the grounding member, the second component is a cable, and each of the at least one first contact location is higher than each of the at least one second contact location.

9. The electrical connector according to claim 6, wherein one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has at least one first contact location connected to the grounding member, the second ground terminal has at least one second contact location connected to the grounding member, the second component is a printed circuit board (PCB), and each of the at least one first contact location is lower than each of the at least one second contact location.

10. The electrical connector according to claim 6, wherein one of the two ground terminals located at the left side and the right side of the signal terminal or the signal terminal group is defined as a first ground terminal, the other of the two ground terminals located at the left side and the right side of the signal terminal or the signal terminal group is defined as a second ground terminal, the first ground terminal has a plurality of first contact locations connected to the grounding member, the second ground terminal has at least one second contact location connected to the grounding member, the second component is a printed circuit board (PCB), and viewing along the left-right direction, at least one of the at least one second contact location is located between two of the first contact locations.

11. The electrical connector according to claim 6, wherein the insulating body has a recess, a pair of differential signal terminals are provided between the two ground terminals, each terminal of the pair of differential signal terminals have an exposing portion located in the same recess, the grounding member has an opening slot and a position limiting portion extending into the opening slot, the position limiting portion is matched and limited with a position limiting block of the insulating body, the opening slot comprises impedance adjusting through slots located at a left side and a right side of the position limiting portion, and viewing along a direction perpendicular to the left-right direction, the impedance adjusting through slots overlap with at least part of the exposing portions.

12. An electrical connector, comprising:
an insulating body;
a grounding member; and
a row of terminals accommodated in the insulating body and arranged side-by-side in a left-right direction, wherein the row of terminals comprise a plurality of pairs of differential signal terminals and a plurality of ground terminals, one of the ground terminals is provided at each of a left side and a right side of each pair of the differential signal terminals, and no other terminal is provided between each pair of the differential signal terminals and the two ground terminals correspondingly located at the left side and the right side thereof;
wherein each of the ground terminals has at least one contact location connected to the grounding member, and a quantity of the at least one contact location of the ground terminal at the left side of each pair of the differential signal terminals is different from a quantity of the at least one contact location of the ground terminal at the right side of each pair of the differential signal terminals.

13. The electrical connector according to claim 12, wherein one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has at least one first contact location connected to the grounding member, the second ground terminal has at least one second contact location connected to the grounding member, and each of the at least one first contact location and each of the at least one second contact location are staggered in the left-right direction.

14. The electrical connector according to claim 12, wherein one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has at least one first contact location connected to the grounding member, the second ground terminal has at least one second contact location connected to the grounding member, the second component is a cable, and each of the at least one first contact location is higher than each of the at least one second contact location.

15. The electrical connector according to claim 12, wherein one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has at least one first contact location connected to the grounding member, the second ground terminal has at least one second contact location connected to the grounding member, the second component is a printed circuit board (PCB), and each of the at least one first contact location is lower than each of the at least one second contact location.

16. The electrical connector according to claim 12, wherein one of the two ground terminals located at the left side and the right side of each pair of differential signal terminals is defined as a first ground terminal, the other of the two ground terminals located at the left side and the right side of each pair of differential signal terminals is defined as a second ground terminal, the first ground terminal has a plurality of first contact locations connected to the grounding member, the second ground terminal has at least one second contact location connected to the grounding member, the second component is a printed circuit board (PCB), and viewing along the left-right direction, at least one of the at least one second contact location is located between two of the first contact locations.

17. The electrical connector according to claim 12, wherein the insulating body has a recess, each of the pair of differential signal terminals have an exposing portion located in the same recess, the grounding member has an opening slot and a position limiting portion extending into the opening slot, the position limiting portion is matched and limited with a position limiting block of the insulating body, the opening slot comprises impedance adjusting through slots located at a left side and a right side of the position limiting portion, and viewing along a direction perpendicular to the left-right direction, the impedance adjusting through slots overlap with at least part of the exposing portions.
